(19) United States
(12) Patent Application Publication
(10) Pub. No.: US 2019/0226807 A1
(43) Pub. Date: Jul. 25, 2019

(54) SYSTEM, METHOD AND APP FOR AUTOMATICALLY ZEROING A FIREARM

(71) Applicant: Thomas R. Boyer, Gambrills, MD (US)

(72) Inventor: Thomas R. Boyer, Gambrills, MD (US)

(21) Appl. No.: 16/254,562

(22) Filed: Jan. 22, 2019

Related U.S. Application Data
(63) Continuation-in-part of application No. 15/615,807, filed on Jun. 6, 2017, now Pat. No. 10,228,219.
(60) Provisional application No. 62/345,864, filed on Jun. 6, 2016.

(51) Int. Cl. F41G 1/54; F41J 2/02; F41J 2/00; G06T 7/50; G06T 7/66

(52) U.S. Cl. CPC F41G 1/54; F41J 2/02; G06T 2207/10004; G06T 7/50; G06T 7/66; F41J 2/00

(57) ABSTRACT

Before a person can use any weapon, such as a gun or a rifle, effectively, the sight must be aligned to the barrel through a zeroing process. Various embodiments discloses a firearm zeroing app for automatically determining the adjustments of a weapon equipped with an optical sight. The system can utilize a mobile device to take a picture to capture an image of a shot group. Then, using the app, the system automatically calculates the datum of the shot group, the centroid of the shot group, and the distance for adjustment of the sighting device to accurately fire the firearm. In another embodiment, the mobile device can be configured to capture and record the image of firing of the firearm so that the app automatically captures as a video the images of the shots fired to establish the shot group and automatically analyzes the projectile's flight path data.

### CROSS-REFERENCE TO RELATED APPLICATIONS

This application is a continuation-in-part of U.S. Ser. No. 15/615,807 filed on Jun. 6, 2017, which claims priority of U.S. Provisional Patent Application Ser. No. 62/345,864, which was filed on Jun. 6, 2016. The subject matter of the earlier filed application is hereby incorporated by reference.

### INCORPORATION BY REFERENCE

All publications, patents, and patent applications mentioned in this specification are herein incorporated by reference in their entirety as if each individual publication or patent application was specifically and individually indicated to be incorporated by reference in its entirety.

### TECHNICAL FIELD OF THE DISCLOSURE

The present disclosure relates generally to an app (i.e., a downloadable self-contained software application) for zeroing a weapon equipped with an optical sight. More particularly, the present disclosure relates to a system and method for zeroing various types of weapon sights, such as, for example, laser sights, night vision sights, and thermal imaging sights, to ensure calibration of the weapon for accurate engagement of a real-life target that instructs the user exactly how to adjust his or her weapon sight to accurately aim at a target.

### BACKGROUND OF THE INVENTION

Many people use weapons for the benefit of civilians including law enforcement officers and members of the Army, Navy, Air Force, and Marines. In order to use a weapon effectively, a person must be able to accurately aim at a target. To accurately engage targets, the strike of a bullet must coincide with the aiming point (Point of Aim/Point of Impact) on the target. Over the years, various techniques and devices have been developed to help a person accurately aim a weapon.

One common approach is to mount a sight on the weapon. A person then uses the sight to view an intended target. The sight must be zeroed before being used on the weapon. Zeroing a firearm, such as a rifle, is the process of aligning the sight on the weapon with the rifle so the user can accurately aim at the target from a set distance. Namely, the user must calibrate the user's sights to their weapons to ensure the user will hit the user's target. Typically, this is accomplished by adjusting the sights on the weapon to achieve a point of aim/point of impact. This zeroing process is one of the most critical elements of accurate target engagement. In order to aim accurately at a target, it is imperative for the sighting mechanism to be properly installed and adjusted on the gun. This is very important whenever the sight is disturbed in any way.

Firearm users make regular practice of zeroing their weapon sight. If the weapon sight is not properly aligned with the firearm, the user could aim at one thing and miss it completely. Zeroing generally requires the user to shoot at a target, and then measure the distance from the point of aim to the point of impact. The weapon sight is then adjusted so that the point of impact is at the point of aim or offset appropriately. Currently, this process is fairly manual. The user estimates the center of the group of shots and measures the distance from the intended location. The user often uses guess work to estimate the correct adjustment for the weapon sight. It can be challenging to detect the shots and analyze their locations.

In some conventional zeroing methods, initially, the user fires a few shots at the center of the target to establish a shot group, which can help the user to determine if the user is firing consistently. The objective is for the shots to impact the target in a tight group, which means that the user is firing consistently. Once the user is able to fire a tight shot group at the target, the user can begin to adjust the sight to bring the group closer to the center of the target. For example, if the shot group impacts on the left side of the target, the user manually adjusts the sight to the right. In another example, if the shot group hits the target low, the user manually adjusts the sight to raise the aiming point. With conventional methods, the user may have to manually repeat this adjustment process a number of times. Once the user is shooting consistently shot groups at center mass of the target, the weapon is “zeroed” for the current distance.

Additionally, many firearms users participate in competitions where they measure their accuracy against other competitors or their previous results. The scoring process can be a laborious, manual process.

Initially when sight technology was developed, the most popular method to aim a weapon was using iron sights seen with the naked eye. Using traditional iron sights, the user fires at the center of a target having multiple lines and an image printed out on a medium, such as a piece of paper, similar to the target shown in FIG. 1. The group of shots should land at a predefined distance away from the target center depending on the weapon and sight characteristics. If the shots do not hit the target where expected, the sights must be adjusted so they will hit the target where they should.

As sights have become more common, a variety of weapon sights has been developed. For example, a person can today choose to use day sights, night vision sights, and thermal sights. In each of these categories, there are many options.

Although existing weapon sights have been generally adequate for their intended purposes, they have not been satisfactory in all respects. For example, sometimes it is difficult or impossible to see or detect the lines on the paper target of FIG. 1 with some sight technologies. Furthermore, laser aiming sights create an additional level of complexity for zeroing a weapon.

As an example to address this problem, targets were developed by Boyer, which is described in U.S. Pat. No. 7,528,397, and by Migliorini, which is described in U.S. Pat. No. 6,337,475, to provide effective means to zero a thermal weapon sight. The disadvantage of these type of sights is that they are calibrated specifically for thermal weapon sights. However, these targets do not work effectively with other sight technologies. Typically, different sights use different adjustment methods. If the user employs a sight different than the thermal weapon sight, accurate shot placement is compromised, because the target does not provide the correct aiming reference. Thus, the user is required to procure and inventory additional targets for other types of sights.

There is a need for a system, method and app directed to zeroing a firearm and scoring a target for a variety of sights when used with a compatible target.

### BRIEF SUMMARY OF THE INVENTION

The present invention may satisfy one or more of the above-mentioned desirable features. Other features and/or advantages my become apparent from the description which follows.

Various embodiments discloses a firearm zeroing app for automatically determining the adjustments of a weapon equipped with an optical sight. The system may include a weapon, such as firearm, that requires zeroing to enable a user to accurately aim at a target. The system can utilize a mobile device as a centralized hub to organize and communicate information between various components of the system.

In one embodiments, it is contemplated that the user, after firing several shots, may manually take a picture to capture an image of the shot group. Then, using the app, the system automatically calculates the datum of the shot group, the centroid of the shot group, and the distance for adjustment of the sighting device to accurately fire the firearm.

In one embodiment, a mobile device can be configured to capture and record the image of firing of the firearm so that the app automatically captures as a video of the images of the shots fired to establish the shot group. Based on the formation of the shot group, in this embodiment, the app automatically calculates the datum of the shot group, the centroid of the shot group, and the distance for adjustment of the sighting device to accurately fire the firearm.

Various embodiments are directed to scoring a target. Many firearms users participate in competitions where they measure their accuracy against other competitors or their previous results. The present invention can be used to facilitate the scoring process, which typically is a laborious, manual process.

Various embodiments are directed to forming targets which may be used as training aides for weapons that are equipped with a sight. The present teaching is directed to a system and method for manufacturing a universal target for use with a variety of sights, such as, for example, laser sights, night vision sights, and thermal imaging sights, to quickly and accurately acquire a real-life target.

### BRIEF DESCRIPTION OF THE DRAWINGS

The skilled artisan will understand that the drawings described below are for illustrative purposes only. The drawings are not intended to limit the scope of the present teachings in any way.

FIG. 1 (prior art) depicts a typical 25-meter calibration target for use with visible sights.

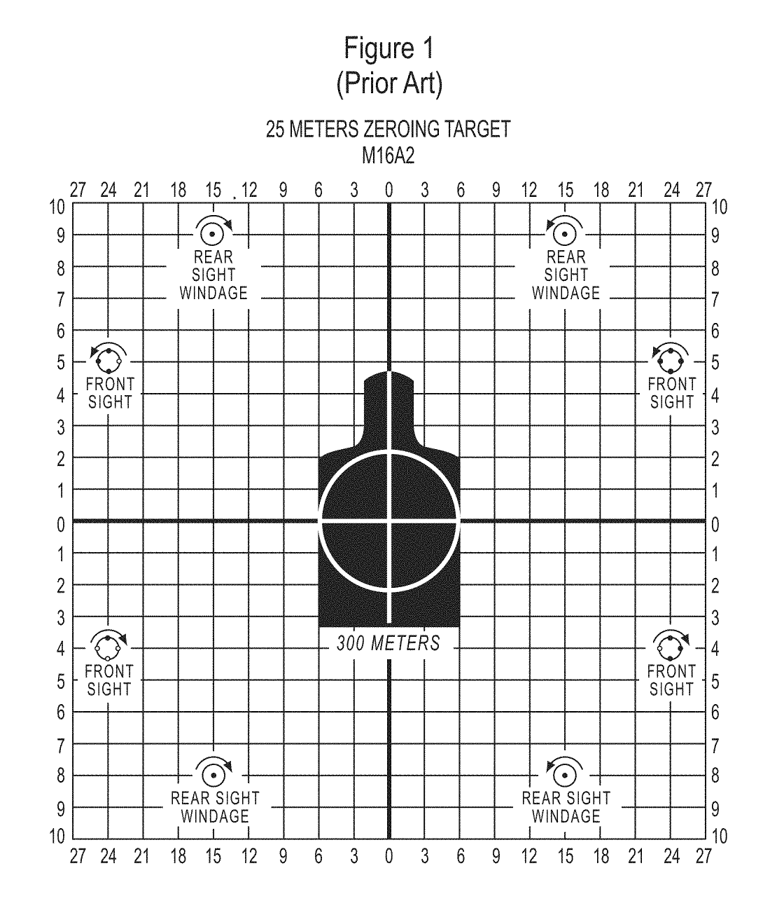

FIG. 2 is an illustration of an exemplary firearm zeroing system according to the present teaching.

FIG. 3 is a front view of one embodiment of a target according to the present teachings.

FIG. 4 shows an instruction sheet that can be used with the target of FIG. 3.

FIG. 5 illustrates an alternative embodiment of a thermal reflective member according to the present teachings.

FIG. 6 depicts another exemplary embodiment of a target according to the present teachings.

FIG. 7 depicts a further exemplary embodiment of a target according to the present teachings.

FIG. 8 is a diagrammatic illustration of an exemplary disclosed graphical user interface that may be used to access the system of FIG. 2.

FIG. 9 is a flow chart of illustrative steps involved in zeroing a firearm in accordance with the present teachings.

FIG. 10 is a flow chart of illustrative steps involved in scoring a target in accordance with the present teachings.

### DETAILED DESCRIPTION OF PREFERRED EMBODIMENTS OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” mechanism +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

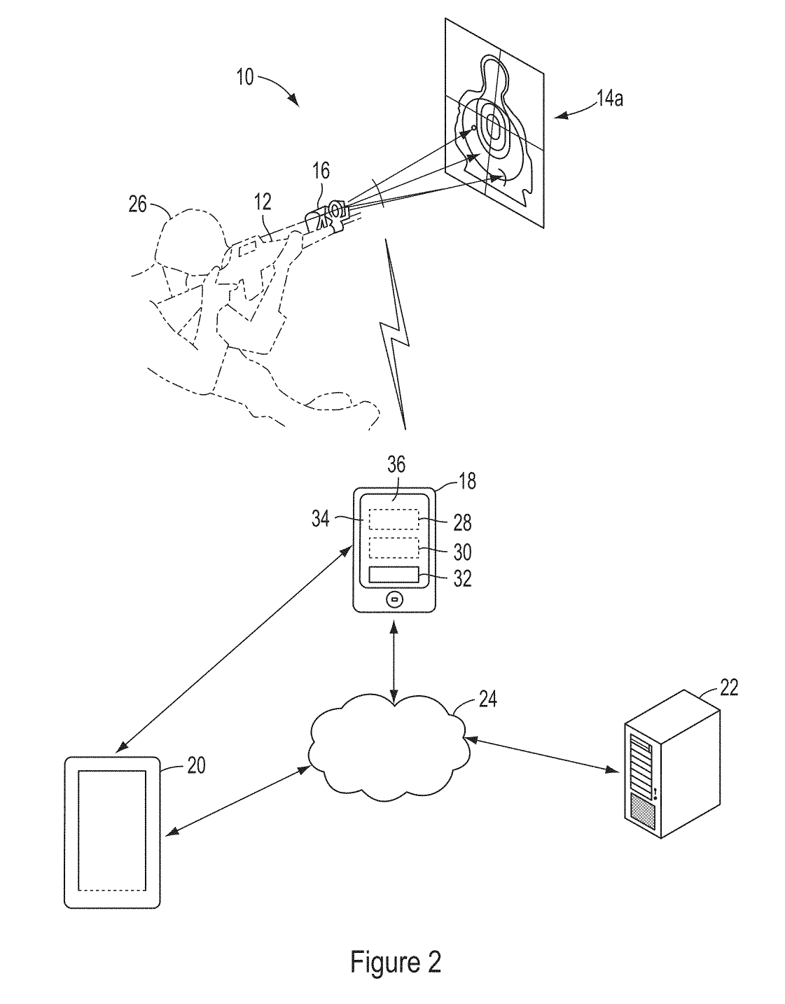

FIG. 2 illustrates an exemplary firearm zeroing system 10 for automatically determining the adjustments of a weapon equipped with an optical sight. System 10 may include a weapon, such as firearm 12, that requires zeroing to enable a user to accurately aim at a target 14a. System 10 utilizes a mobile device 18 as a centralized hub to organize and communicate information between various components of the system, as will be discussed in further detail below.

In various embodiments, the system, method and app relates to zeroing a firearm 12. Firearm 12 may take may different forms. In the example shown in FIG. 2, firearm 12 is a rifle. Specifically, firearm 12 may include an aiming device, such as a sighting device 16 mounted on the firearm barrel thereon to assist user 26 with aligning firearm 12 with intended target 14a. In various embodiments, sighting device 16 may include a front sight, located on the firearm barrel near the muzzle of the barrel, and a rear sight, located near the rear of the barrel. In order to shoot the firearm accurately, the user must line up the front sight and the rear sight, and then line up the sights up with the intended target 14a.

It should be understood that the exemplary embodiments may be used with any type of firearm and sights used with firearms, including, without limitations, such as rifles, carbines, pistols, shotguns, hand guns, long guns and the like.

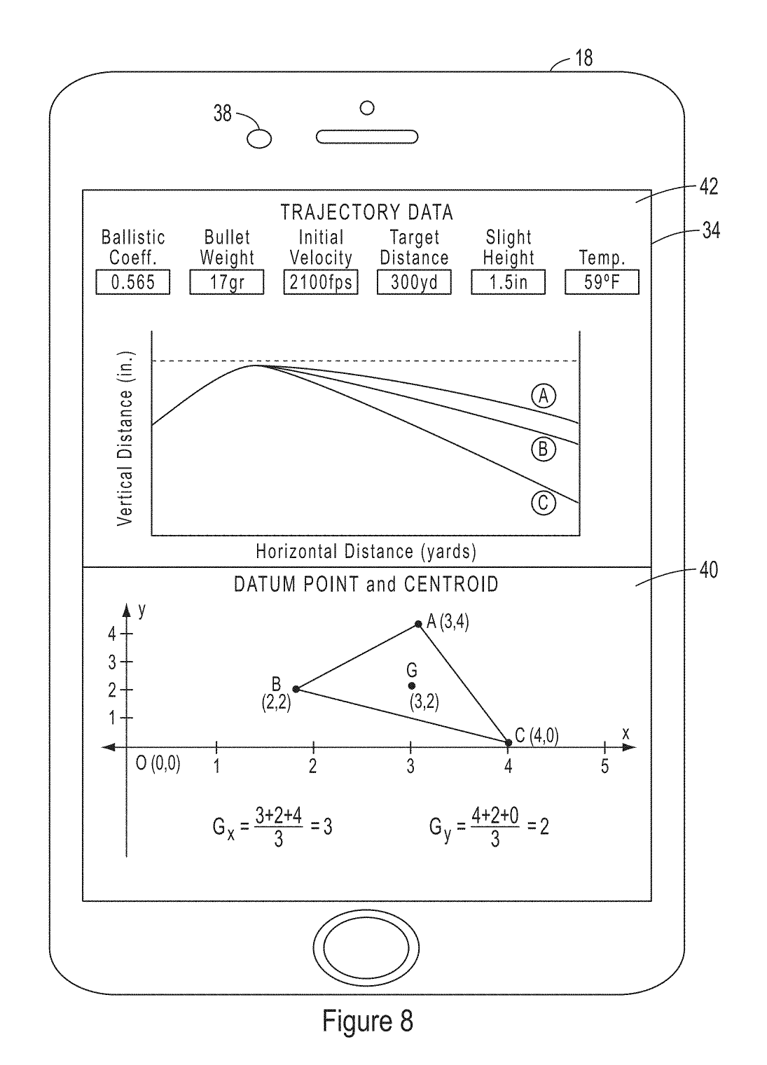

The system, method and app may be utilized with various types of targets to facilitate zeroing a firearm, The system, method and app may additionally be utilized for entertainment purposes (e.g. scoring a target in target shooting games or sporting competitions). The system 10 can incorporate a camera 38 (FIG. 8) from the mobile device 18 to capture an image of the shot group fired upon a target 14a and process the image data to provide adjustment and zeroing information.

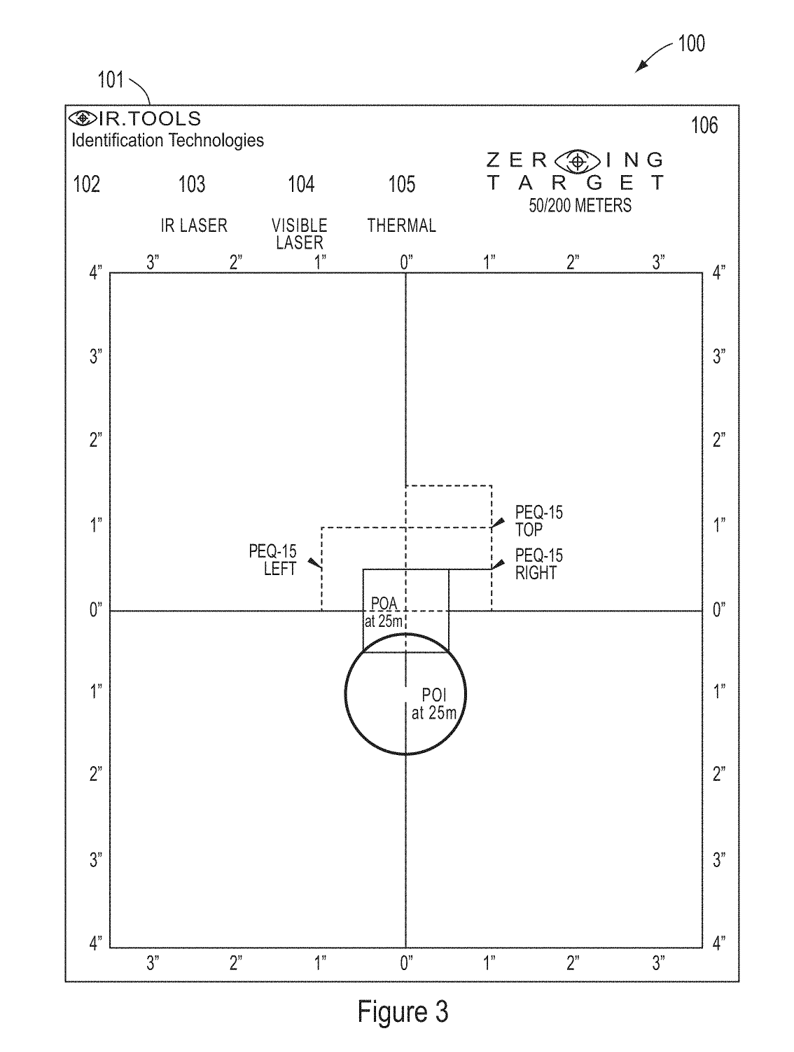

By way of example, only, an exemplary embodiment of a target 100 that can be used, for example, to zero or align a sight according to the present teachings is illustrated in FIG. 3. Any target other than the targets disclosed herein in FIGS. 3-6 may be used in conjunction with the system, method and app of the present teachings to adjust and zero an attached sighting device.

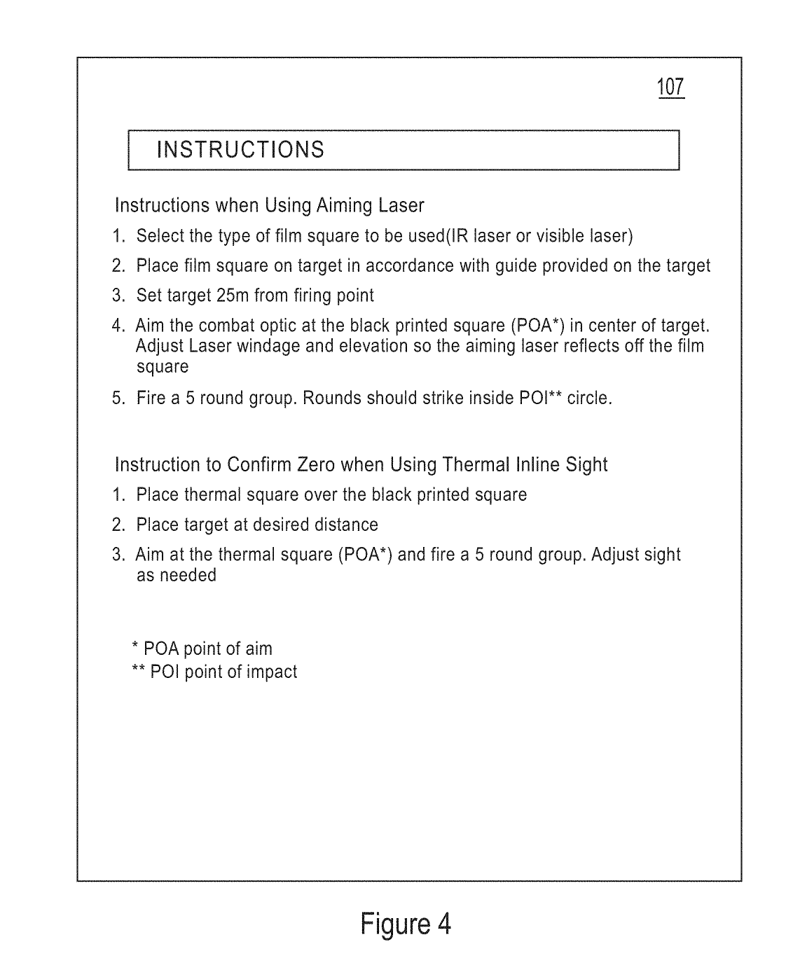

In the preferred embodiment, the target 100 can comprise multiple members. According to one preferred embodiment, the target 100 may consist of five laminar members 101, 102, 103, 104, 105 as depicted in FIG. 3. Laminar member 101 includes a first surface 106 and second surface 107 (FIG. 4). In various exemplary embodiments, such as, for example, in the exemplary embodiment of FIG. 3, the laminar member 101 can be a film, such as, for example, a polymer film or a paper. In the exemplary embodiments, the laminar member can be a paper approximately 8.5 inches by 11 inches and is resistant to water.

In an embodiment, laminar member 102 includes a first surface and second surface. The first surface can be, for example, photo-luminescent such that it can absorb energy from the environment and then release the energy again. The second surface can be adhesive so that it can be affixed to an appropriate location on the first surface 106 of laminar member 101. The photo-luminescent surface can be advantageous when using a night vision sight. The photo-luminescent surface can be used with night vision sights to identify a point of aim without the user having to use infrared illumination. In use, laminar member 102 can be placed in the center of the target at the point of aim (POA), and then charged using a light source. The POA is then easily visible by the shooter trying to zero his weapon. Laminar member 102 can be fabricated from readily available rolls or sheets of photo-luminescent film. In the preferred embodiment, a product based on Strontium Aluminate is preferred over one based on Zinc Sulfide.

In an embodiment, laminar piece 103 includes a first surface and second surface. The first surface is retro-reflective to near infrared energy (in a range of approximately 0.7 u to 3 u) only, such that it can retro-reflect incident near infrared energy and absorb visible light. The term “retro-reflection” should be understood to mean that incident energy is reflected back toward its source irrespective of the position of the reflector. The second surface has adhesive properties so that it can be affixed to an appropriate location on the first surface 106 of laminar member 101. This retro-reflective property provides another advantage when using a night vision sight. During use, laminar member 103 can be placed in the center of the target at the point of aim (POA). The shooter illuminates laminar member 103 with his infrared illuminator and then the POA is easily visible by the shooter trying to zero his weapon. Alternatively, laminar member 103 can be used with an infrared aiming laser to position the aiming laser. In such an embodiment, laminar member 103 is placed at a desired distance away from the POA such that, when the laser is focused exactly on laminar member 103, the weapon is aimed exactly at the POA. Laminar member 103 can be fabricated, for example, from readily available master rolls or sheets of infrared (IR) glow film, commonly known as, IR glint tape.

In the preferred embodiment, laminar member 104 includes a first surface and second surface. The first surface is retroreflective to white light. As defined above, retro-reflection means that incident energy is reflected back toward its source irrespective of the position of the reflector. The second surface has adhesive properties so that it can be affixed to an appropriate location on the first surface 106 of laminar member 101. Having a surface that is retroreflective to white light provides an additional advantage when using a night vision sight. The white light retro-reflective film can be used with a visible aiming laser to position the aiming laser. When in use, laminar member 104 can be placed in the center of the target at the point of aim (POA). The shooter illuminates laminar member 104 with his infrared illuminator and then the POA is easily visible by the shooter trying to zero his weapon. Alternatively, target 100 having a laminar member 104 with a surface that is retroreflective to white light can be used with an infrared aiming laser. In such an exemplary embodiment, laminar member 104 is placed at a desired distance away from the POA such that when the laser is focused exactly on laminar member 104, the weapon is aimed exactly at the POA. In an example, laminar member 104 can be readily fabricated, for example, from master rolls or sheets of retroreflective film.

In an embodiment, laminar piece 105 includes a first surface and second surface. The first surface is reflective to thermal energy (in a range of approximately 3 u to 12 u) and also has the characteristic of very low emissivity (emissivity value of about 0.4 or less). The second surface has adhesive properties so that it can be affixed to an appropriate location on first surface 106 of laminar member 101. This thermal reflective attribute provides an advantage using a thermal sight. The thermal reflecting film can be used with thermal weapon sights to identify the point of aim (POA). In use, laminar member 105 can be placed in the center of the target at the POA. When viewed with the thermal sight, the POA will then appear to exhibit a different temperature than the surrounding paper, providing a convenient way to find the POA. In an exemplary embodiment, laminar member 105 can be readily fabricated from master rolls or sheets of no power film, such as, for example, AKA thermal film, thermal target film, or low emissivity film.

In various embodiments, laminar members 102, 103, 104, 105, having adhesive release properties, such as stickers, can initially be placed on a certain area of first surface 106 of laminar member 101. This adhesive property allows the laminar members to be easily removed and placed permanently in the appropriate locations.

Namely, in various embodiments a laminar target 101 is provided having a first surface 106 and a second surface 107 bearing multiple pieces of film 102-105, each having first and second surfaces and various optical properties, enabling the user to calibrate a variety weapon sighting technologies, including night vision, thermal imaging, and aiming lasers, using a single device. The multiple pieces of film 102-105 are covered with adhesive on the second surface and adhered to the first surface of the target such that they can be repositioned.

In some embodiments of the zeroing process, not all laminar members 102-105 may be used for each zeroing operation. In some embodiments, one laminar member or a combination of selective laminar members may be employed for a specific application.

As depicted in FIGS. 3-4, first surface 106 and second surface 107 can be positioned below the target grid and printed to include an instruction sheet listing instructions and data for the user to aid them in how to use the target and where to place the appropriate components. In alternate embodiment, when the target in FIGS. 3-4 is used in conjunction with the system, method and app in FIGS. 2 and 8, the instructions and data can be provided to the user electronically via mobile device 18.

In various embodiments, laminar member 101 can be made using standard printing arts including screen printing, digital printing, and offset printing. The inks do not require any special characteristics compared to the most commonly used black inks. A design consisting of words, graphics, or any other creation can be printed on the first surface 106, the second surface 107 or a combination thereof. For example, on the first surface 106, a 25 Meter Zeroing Target or any other object or pattern of interest may be printed. An exemplary sample target appears in FIGS. 3 and. The printing has the characteristic of being the proper thickness and type such that design on the printed locations on the surface(s) when viewed through a variety of sight devices will be readily apparent. Using this invention, any conceivable design can be created using traditional printing means, such as a silk screening. It should be understood that any technology used to print and any design falls within the scope of this patent.

In an alternate embodiment, one or more of laminar members 102-105 may be eliminated from target 100 if any of these laminar members are not required for certain applications.

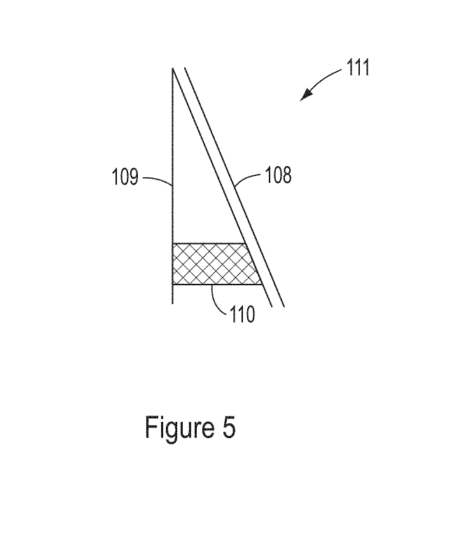

In another alternate embodiment as illustrated in FIG. 5, laminar member 105 can be replaced with a non-laminar member 111 that is configured having, for example, a triangular shape. In this example, the non-laminar member 111 is depicted as a triangular shape, but it is clear that any shape can be used, such as rectangular, square, and the like. Non-laminar member 111 is comprised of members 108, 109, and 110. Member 108 is a thermally reflective film, similar to laminar member 105. Member 108 is permanently adhered to member 109, which is a laminar that is folded over to form a hinge. In the preferred embodiment, member 109 is a folded paper or polymer film. Member 110 is a space filling component configured to maintain an angle in member 109. For example, in the preferred embodiment, member 109 may be configured to maintain an angle approximately within a range of 5 degrees to 30 degrees. In some embodiments, even more preferable, member 109 may be configured to maintain an angle approximately within a range of 10 degrees to 20 degrees. In one embodiment, member 110 is a compressible elastic material that allows member 111 to compress to be flat for packaging, and expand at a predetermined angle during use. In various embodiments, member 110 is an elastomeric foam with adhesive provided on two surfaces.

Member 111 is configured to be superior to laminar member 105 in its ability to provide greater thermal difference in comparison to first surface 106. In yet a further additional alternate embodiment, member 110 may be omitted from the target. In such an embodiment, the user may adjust member 109 to an optimal angle during use. For example, in the preferred embodiment, member 109 may be configured to maintain an angle approximately within a range of 5 degrees to 30 degrees. In some embodiments, even more preferable, member 109 may be configured to maintain an angle approximately within a range of 10 degrees to 20 degrees.

Namely, in various embodiments, a laminar target is provided having a first and second surface bearing multiple pieces of film, each having first and second surfaces and various optical properties, enabling the user to calibrate a variety weapon sighting technologies, including night vision, thermal imaging, and aiming lasers, using a single device. The multiple pieces of film are covered with adhesive on the second surface and adhered to the first surface of the target such that they can be repositioned. The piece of film detectable with thermal weapon sight has a triangular cross-section causing its first surface to sit at an angle with respect to the first surface of the laminar target.

In an example prepared according to the present teachings, a target was printed on Rite in the Rain paper having a standard letter size of 8½ inches wide by 11 inches long. The photo-luminescent member was cut from Jessup Manufacturing part 7560. The IR retro-reflective member was cut from IR.Tools film. The white light reflective member was cut from Orafol retroreflective film. The thermal film part member was cut from IR. Tools film CID-THRM-T4166. Each of the film members was adhered to the target using a glue dot between its release liner and the target.

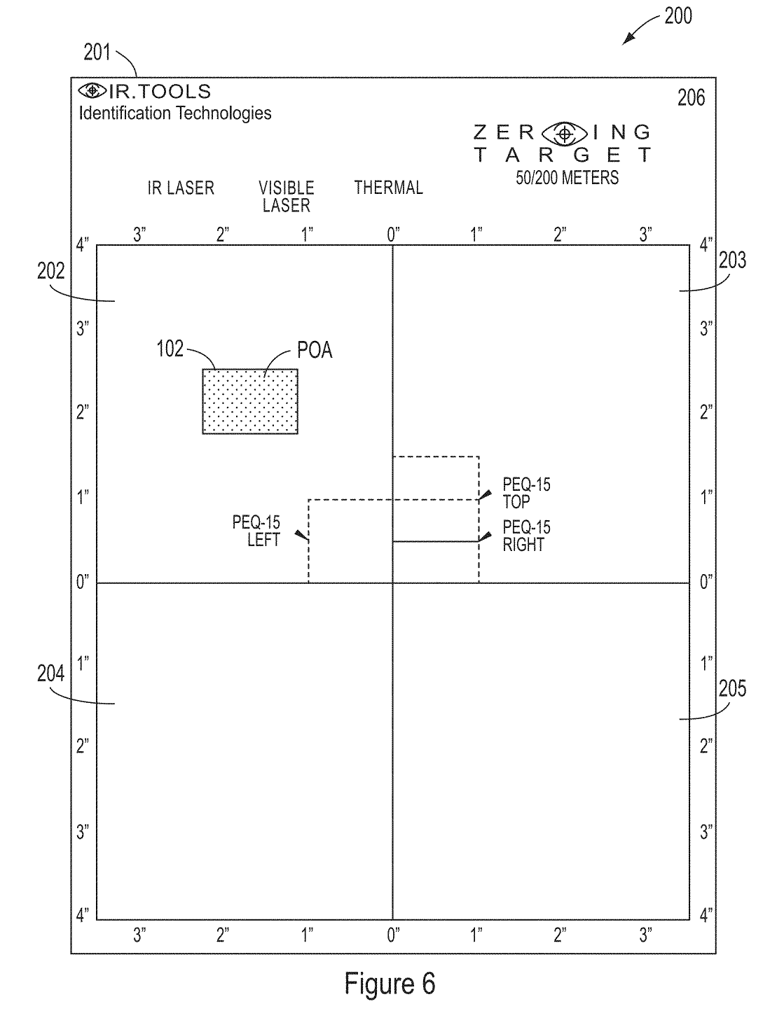

In another embodiment, a universal target 200 that can be used to zero a variety of sights, such as, for example, laser sights, night vision sights, and thermal imaging sights, is illustrated in FIG. 6. Target 200 is preferably a laminar member 201 having various optical properties that are divided into four quadrants 202, 203, 204, 205. Each quadrant is designed having a different optical property so that each quadrant is associated with one optical property. By way of example, quadrant 202 is configured similar to laminar member 102 having a photo-luminescent film that can be used with night vision sights to identify a point of aim without using infrared illumination by the shooter. Quadrant 203 is configured similar to laminar member 103 having a near infrared retro-reflective film that can be used with night vision sights to identify a point of aim and with infrared (IR) aiming laser to position aiming lasers. Quadrant 204 is configured similar to laminar member 104 having a white light retro-reflective film that can be used with visible aiming laser to position aiming lasers. Quadrant 205 is configured similar to laminar member 105 having a thermal reflecting film that can be used with thermal weapon sights to identify a point of aim.

By way of example with respect to quadrant 202 and laminar member 102, in operation, the shooter uses a light source to charge laminar member 102, which may be provided, for example, at a center location or any other location within quadrant 202 at the point of aim. The point of aim is then easily visible within quadrant 202 by the shooter trying to zero his weapon. Those having skill in the art would recognize that laminar member 202 may be divided into quadrants having more or less than the four quadrants as depicted in FIG. 6.

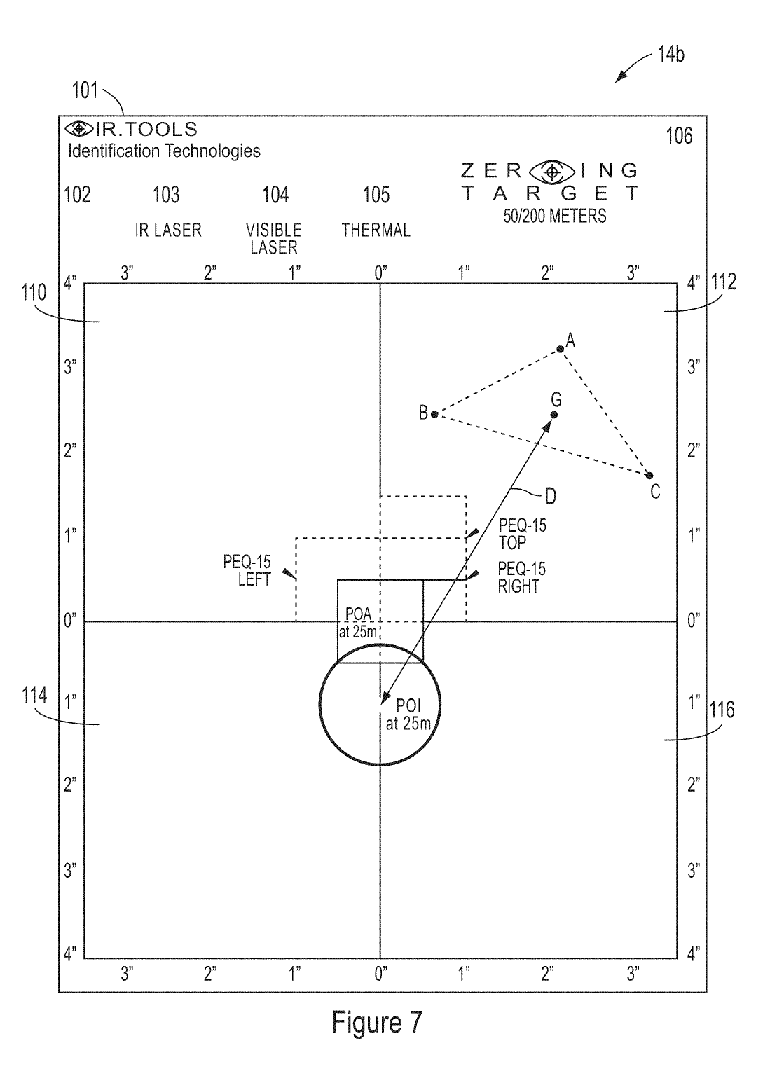

Referring back to FIG. 2, in various embodiments, the system, method and app may be utilized with targets 100, 200 (FIGS. 3-6) and any other known compatible target 14a to facilitate zeroing a firearm. As depicted in the exemplary embodiment of FIG. 2, mobile device 18 may communicate with user 26 and remote resources, such as, for example, computing device 20 and/or server 22 capable of communicating with mobile device 18 via a network 24, consistent with disclosed embodiments. In some embodiments, mobile device 18 may capture and analyze image data, identify one or more shots fired at an intended target 14a, 14b (FIGS. 2 and 7) present in the image data, and perform an analysis and/or provide feedback to user 26. In some embodiments, computing device 20 and/or server 22 may provide additional functionality to enhance interactions of user 26 with the user's environment, as described in greater detail below.

According to the disclosed embodiments, mobile device 18 may include an image sensor system 30 for capturing real-time image data of the target 14a, 14b. In some embodiments, mobile device 18 may also include a processing unit 28 for controlling and performing the disclosed functionality of mobile device 18, such as to control the capture of image data, analyze the image data, and perform an analysis and/or output a feedback based on one or more shots fired identified in the image data. Additionally, in some embodiments, mobile device 18 may include a feedback outputting unit 32 for producing an output of information to user 26.

As discussed above, mobile device 18 may include an image sensor 30 for capturing image data. The term “image sensor” refers to a device capable of detecting and converting optical signals in the near-infrared, infrared, visible, and ultraviolet spectrums into electrical signals. The electrical signals may be used to form an image or a video stream (i.e. image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS). In some cases, image sensor 30 may be part of a camera 38 included in mobile device 18.

Mobile device 18 may also include processor 28 for controlling image sensor 30 to capture image data and for analyzing the image data according to the disclosed embodiments. Processor 28 may include a “processing device” for performing logic operations on one or more inputs of image data and other data according to stored or accessible software instructions providing desired functionality. In some embodiments, processor 28 may also control feedback outputting unit 32 to provide feedback to user 26 including information based on the analyzed image data and the stored software instructions. As the term is used herein, a “processing device” may access memory where executable instructions are stored or, in some embodiments, a “processing device” itself may include executable instructions (e.g., stored in memory included in the processing device).

Feedback outputting unit 32 may include one or more feedback systems for providing the output of information to user 26. In the disclosed embodiments, audible or visual feedback may be provided via any type of connected audible or visual system or both. Feedback of information according to the disclosed embodiments may include audible feedback to user 26 (e.g., using a Bluetooth™ or other wired or wirelessly connected speaker, or a bone conduction headphone). Feedback outputting unit 32 of some embodiments may additionally or alternatively produce a visible output of information to user 26, for example, such as a display 34 provided as part of mobile device 18.

In some embodiments, mobile device 18 includes a smartphone having a camera and a display. Other examples of mobile device 18 includes a PC, laptop or tablet, etc. In an embodiment in which mobile device 18 is a smartphone, mobile device 18 may have a dedicated application installed therein. For example, user 26 may view on display 34 data (e.g., images, video clips, extracted information, feedback information, etc.) that is obtained by mobile device 18. In addition, user 26 may select part of the data for storage in server 22.

Audio component of the mobile device 18 may include speakers and tone generators for presenting sound to a user of the mobile device 18 and microphones for gathering user audio input.

Display 34 may be used to present images for a user such as text, video and still images. The sensors may include a touch sensor array that is formed as one of the layers of display 34.

User input may be gathered using buttons and other input-output components (not shown) such as touch pad sensors, buttons, joysticks, click wheels, scrolling wheels, touch sensors, such as sensors in the display, key pads, keyboard, vibrators, camera, and other input-output components.

Mobile device 18 can also connect to computing device 20 over network 24 via any known wireless standard (e.g., Wi-Fi, Bluetooth®, etc.), as well as near-filed capacitive coupling, and other short range wireless techniques, or via a wired connection. Computing device 20 can include one or more central processing units (CPUs) and a system memory. Computing device 20 can also include one or more graphics processing units (GPUs) and graphic memory. The CPUs can be single or multiple microprocessors, field-programmable gate arrays, or digital signal processors capable of executing sets of instructions stored in a memory, a cache, or a register. The CPUs can contain one or more registers for storing variable types of data including, inter alia, data, instructions, floating point values, conditional values, memory addresses for locations in memory (e.g., system memory or graphic memory), pointers, and counters. The CPU registers can include special purpose registers used to store data associated with executing instructions such as an instruction pointer, instruction counter, and/or memory stack pointer. The system memory can include a tangible and/or non-transitory computer-readable medium, such as a flexible disk, a hard disk, a compact disk read-only memory (CD-ROM), magneto-optical (MO) drive, digital versatile disk random-access memory (DVD-RAM), a solid-state disk (SSD), a flash drive and/or flash memory, processor cache, memory register, or a semiconductor memory.

Network 24 may be a shared, public, or private network, may encompass a wide area or local area, and may be implemented through any suitable combination of wired and/or wireless communication networks. Network 24 may further comprise an intranet or the Internet. In some embodiments, network 24 may include short range or near-field wireless communication systems for enabling communication between system components provided in close proximity to each other. Mobile device 18 may establish a connection to network 24 autonomously, for example, using a wireless module (e.g., Wi-Fi, cellular). In some embodiments, mobile device 18 may use the wireless module when being connected to an external power source, to prolong battery life. Further, communication between mobile device 18 and server 22 may be accomplished through any suitable communication channels, such as, for example, a telephone network, an extranet, an intranet, the Internet, satellite communications, off-line communications, wireless communications, transponder communications, a local area network (LAN), a wide area network (WAN), and a virtual private network (VPN).

As shown in FIG. 2, mobile device 18 may transfer or receive data to/from server 22 via network 22. In the disclosed embodiments, the data being received from server 22 and/or computing device 20 may include numerous different types of information based on the analyzed image data and any other information capable of being stored in or accessed by server 22. In some embodiments, data may be received and transferred via computing device 20. Server 22 and/or computing device 20 may retrieve information from different data sources (e.g., a user specific database, the Internet, and other managed or accessible databases) and provide information to mobile device 18 related to the analyzed image data according to the disclosed embodiments.

Mobile device 18 can include a user interface element 36 that comprises, in an example embodiment, an application, or app (“firearm zeroing app”), executed by processor 28 in mobile device 18. User interface 36 enables the automatic evaluation of the image, data entry, GPS information and maintain records from previous analysis. Mobile device 18 comprises in an example embodiment a portable electronic device such as a smartphone, a mobile phone, a smartwatch, a PDA, a tablet computer, a laptop computer or other mobile devices. Mobile device 18 comprises common elements and functionalities known to a skilled person, such as a communication interface, a processor, a memory, an input/output (I/O) unit a user interface (U/I) unit, such as a touch sensitive display.

Mobile device 18 can be, and hence the applications executed by the processor thereof are, configured to communicate over one or more local links and/or to implement telecommunication links suited for establishing links with other users or for data transfer, e.g. using the Internet. For connecting to the internet, mobile device 18 can be configured to establish a connection for example using a cellular or mobile operator network, such as a 3G, GPRS, EDGE, CDMA, WCDMA or LTE network. Further telecommunication links may be links using any of: wireless local area network links, Bluetooth, ultra-wideband, cellular or satellite communication links.

In some embodiments, for example, when the mobile device 18 is a portable electronic device, the application can be a mobile app (“firearm zeroing app”), which is downloadable to and executable by the mobile device 18 (e.g., a laptop, a smart phone, or a tablet.) The disclosed system 10 can provide a graphical user interface (GUI) 36 that is configured to operate in conjunction with the firearm zeroing app to display information about a firearm zeroing operation to user of firearm 12 and that receives input from the user used to configure acquisition of operational data by sensors to transmit operational data to processors, computing devices and/or controllers to receive and display information about the firearm zeroing operation.

In general, the system, method and app provides the ability to analyze one or more shots fired upon a target to accurately and impartially zero a sighting device attached to a firearm. In the preferred embodiment for zeroing a firearm, user 26 can position a compatible target 14a, 14b, 100, 200 at an appropriate distance at a firing range. Specifically in reference to FIGS. 2, and 7-8, using firearm 12 having sighting device 16 mounted thereon, user 26 can then fire a plurality of shots at the target 14a, 14b to form a shot group (A, B, C) (shown in FIG. 7) that impacts the target 14b within a selected area.

After user 26 fires upon target 14a, 14b to establish the shot group, the system, method and app can obtain an assessment of the shot group to determine the user's firing accuracy and sight adjustments that are needed.

After shooting, user 26 can use camera 38 from mobile device 18 to capture an image of the shot group by taking a picture of the bullet holes impacted upon target 14a, 14b. Using the data of the image captured of the shot group, the app determines the datum of the bullet impact holes and identifies the centroid of the respective bullet impact holes. The mobile app system according to the present teachings will automatically determine the datum and centroid of the shot group with respect to the point of impact and calculate the needed sight adjustments. Using the camera to take an image provides a more permanent record of the results and enables more precise and quicker evaluation through software.

In conventional techniques, sight adjustment is typically achieved visually, however, using the system, method and app according to the present teachings provides a more objective analysis, provides archived images, and generates a database of analyses for future reference. Information about, for example, the shot group, calculated datum, calculated centroid, sight adjustment calculations, the firearm, and distance, can be entered, saved and searched. Based on the calculated datum and centroid, the required sight adjustments are calculated and then provided to the user.

Sensors (not shown) installed within mobile device 18 may be configured to monitor parameters associated with firing and zeroing of the firearm and to generate signals indicative thereof. For example, as depicted on display screen 34 of mobile device 18 in FIG. 8, the sensors can be used for capturing an image of the shots fired upon a target, determining the datum points, calculating the respective centroid and calculating the distance adjustment required for the sighting device. In an additional embodiment, the sensors can be used for detecting and tracking an object, such as one or more shots being fired from a firearm. Each of the sensors may be any type of device known in the art. Mobile device 18 may include sensors and status indicators such as ambient light sensor, a proximity sensor, a temperature sensor, a pressure sensor, a magnetic sensor, an accelerometer, light-emitting diodes and other components for gathering information about the system 10 in which mobile device 18 is operating and providing information to a user of the device.

In various embodiments, mobile device 18 may include a locating device (not shown), such as a GPS sensor, configured to generate signals indicative of a geographical position and/or orientation of mobile device 18 and/or one or more of the shots fired upon the target relative to a local reference point, a coordinate system associated with system 10, a coordinate system associated with Earth, or any other type of 2-D or 3-D coordinate system. For example, locating device may embody an electronic receiver configured to communicate with satellites, or a local radio or laser transmitting system used to determine a relative geographical location of itself. In various embodiments, locating device may receive and analyze high-frequency, low-power radio or laser signals from multiple locations to triangulate a relative 3-D geographical position and orientation.

The system may be configured to facilitate communications between the various components within the system 10. The communication devices installed on one or more of the system components may include hardware and/or software that enable the sending or and/or receiving of data through a communication link. The communication link may include satellite, cellular, infrared, radio, and any other type of wireless communications. Alternatively, the communications link may include electrical, optical, or any other type of wired communications, if desired.

In various embodiments, the system, method and app comprises, in an example embodiment, an imaging analysis component configured to image one or more shots fired upon a target. In some embodiments, the imaging analysis component can be incorporated into or integrated with the mobile device 18. In other embodiments, the imaging analysis component can be component or a sub-routine within other components, such as the computing device 20, within the system. This is, in an example embodiment, done in order to ascertain the shot group of the shots fired from a firearm that impacts a target to determine the datum and the centroid of the shot group and calculate the distance for the adjustments needed for zeroing the sighting device mounted upon the firearm. The imaging analysis component can comprise, for example, a conventional imaging system, such as video camera, digital video camera, digital still camera, thermal imaging camera, a 3D-camera or a laser camera. In an example embodiment, the imaging analysis component comprises further elements needed for recognizing objects in the imaged image, such as a processor and memory configured to cause recognizing and processing information from the image, for example, of the shots fired upon a target.

Implementation of the method and process of the imaging analysis component may be embodied partially or completely in, and fully automated via, software code modules, as an image analysis module, executed by one or more general purpose computers or processors. The image analysis module may be stored on any type of computer-readable medium or other computer storage device. Using the image analysis module, one or more image analysis algorithm can be applied to the image data captured by the image sensor 30 to determine system and operational parameter values for calibrating and zeroing the firearm, such as, for example, the datum point, centroid, and trajectory data. The image analysis module can be selected from a selectable menu including a list or toolbox commands displayed on display screen 34 of mobile device 18. Mobile device 18 may be configured so that the components of the image analysis module and the toolbox may communicate and/or interact with the firearm zeroing app.

In one embodiments, it is contemplated that the user, after firing one or more shots, may manually take a picture to capture an image of the shot group. Then, using the app, the system automatically analyzes the image data, calculates the datum of the shot group, the centroid of the shot group, and the distance for adjustment of the sighting device to accurately fire the firearm.

According to the present teachings, a firearm zeroing app may be used to accurately and impartially analyze the targets to precisely align the sighting device upon the firearm. To accurately align the sighting device, the app may be used to specify a point, line or area on target 14a, 14b to establish a datum. The datum serves as a reference as to the location where the shots have impacted the surface of target 14a, 14b in determining the distance measurement for adjusting and aligning sighting device 16. To adjust and align sighting device 16, the firearm zeroing app may identify one or more datum adjustment features, for example, such as, bullet impact holes, edges or corners of the target, a particular shape of the target, fiducials, structures or surface features of the target, bullet or other system components that may be recognized by the imaging analysis component.

After detecting the datum points, firearm zeroing app calculates a “centroid” within an identified region about the selected datum points. Camera 38 within mobile device 18 may capture images of the datum adjustment features, such as bullet impact holes on the target 14a, 14b and determines the location of the bullet impact holes relative to each other and define a selected region. Based on this information, the app may determine the centroid.

In one example as depicted in FIGS. 2, and 7-8, user can position a compatible target 14b at an appropriate distance at a firing range. User 26 may fire, for example, approximately 3 to 5 shots at target 14b. In FIG. 7, target 14b is similar to the exemplary embodiment in FIG. 3, with the addition of a depiction of three bullet holes A, B, C impacted upon target 14b within a selected defined as the upper-right hand quadrant 112. In this example, the app in performing the calculations divides the target 14b into four quadrants 110, 112, 114, 116. Those having skill in the art would recognize that the app may divide the target into quadrants having more or less than the four quadrants as depicted in FIG. 7 or define the selected area into any shape, such as, for example, square, rectangle, circle, triangle, hexagon, rhombus, trapezoid, octagon, parallelogram, and pentagon.

In one embodiment illustrated in FIG. 7, after shooting the bullets upon target 14b, camera 38 of mobile device 18 can be used to capture a picture of the location the three bullet impact holes A, B, C, which are representative of the shots fired on target 14b. Camera 38 within the mobile device 18 may include a digital image sensor that captures digital image data for analysis by, for example, image analysis module, and processing by processor 28 or computing device 20. Camera 38 may have sufficient resolution for capturing images of the bullet impact holes A, B, C, on the surface of the target 14b and images of other structures and features.

In the exemplary embodiments, FIGS. 7-8 depict three bullet impact holes A, B, C, which represents three shots as impacting target 14b within a selected area (the upper right-quadrant 112) during the firing process. It should be understood that the number of bullet impact holes depicted in FIGS. 7-8 are exemplary only and those having ordinary skill in the art would appreciate that a variety of targets having differing configurations, materials and bullet impact holes numbers (e.g. other than 3) may be substituted for or used in conjunction with the present system. Moreover, configurations of the target and number of bullet impact holes may be selected depending on a variety of parameters, such as, the type of firearm, bullet characteristics, and environmental conditions.

Once the image has been captured and the data received into the system, using a software component, such as the image analysis module, the firearm zeroing app can identify the location of numerous datum points based on the shots impacted on target 14b in order to determine the target center. In some circumstances, some datum points may be inadvertently destroyed by the impact of another shot; therefore, the app identifies the shots that can be best detected by the imaging analysis component and determine their locations.

In FIG. 8, the Datum and Centroid data 40 is shown on display 34 of mobile device 18, wherein the app labels and assigns datum points A_{x,y}, B_{x,y}, C_{x,y}, based on the respective individual shot holes A, B, C in FIG. 7. In the example embodiment of FIG. 8, the x, y coordinates of the datum points A_{x,y}, B_{x,y}, C_{x,y} are positioned to form a shape defining a triangle. In other words, in this example, the profile of the shot group defines the shape of a triangle. Thus, in this simple example, the app calculates the centroid of a triangle, which is the point where the triangle's three medians intersect. It is also the center of gravity of the triangle in FIG. 8.

In FIG. 8, the app, based on the datum points A_{x,y}, B_{x,y}, C_{x,y}, calculates the distance to the target center (centroid G_{x,y} of the triangle). The distance vectors of all the bullet impact holes are averaged together to determine the centroid G_{x,y} or average location for the shot group within the selected area (upper-right hand quadrant 112 in FIG. 7). In other words, centroid G_{x,y} is the mean position of all the data points in the selected area. The app calculates the distance from the centroid G_{x,y} to the desired point of impact as a measure of accuracy. The average distance from each hole to every other hole is also calculated. This is a measure of precision. The distance D from the centroid G_{x,y} to the desired point of impact dictates the required weapon sight adjustments.

In various embodiments, such as when the coordinates of numerous bullet impact holes are located within different quadrants or the coordinates of the shot group forms a one or more complex shapes, the processor 28 and/or computing device 20 may determine the centroid G_{x,y} based on the (x, y) coordinates of each datum point of the bullet impact holes A, B, C. The centroid G_{x,y} may be calculated using the following equation:

X*A=Σ(Xi*Ai)

or

y̅*A=Σ(Yi*Ai)

The variables in the equation for the X-Axis centroid,
X̅=The location of the centroid in the X Axis
A=The total area of all the shapes
Xi=The distance from the datum or reference axis to the center of the shape i
Ai=The area of shape i.

Those having skill in the art would recognize that the app may define the selected area to constitute any centroid shape, such as, for example, rectangle, triangle, right triangle, semicircle, quarter circle, circular sector, segment of an arc, semicircular arc, and an area under a spandrel.

After completion of the data analysis, feedback outputting unit 32 outputs to the user information, such as, the sighting device adjustment and zeroing information and/or adjustment orientation information. In some embodiments, audible or visual feedback may be provided to the user. the output information can be displayed on the display screen of the mobile device as an image data or video data.

In the preferred embodiment for scoring a target, the user may follow the training regimen related to the target in use. After shooting is complete and the range is safe, the user can take a picture of the target. The app first locates the various datum marks on the target, as described above. The app then scores the target based on the rules associated with that the specific sporting competition.

In another operational embodiment, prior to shooting the shots to establish the shot group, the user can configure mobile device 18 to operate in video mode to capture the video image of firing the shots during the zeroing operation. Then, the user initiates the app installed on the mobile device 18 to issue instructions to configure one or more sensors in conjunction with the video features of the mobile device 18 to monitor parameters associated with the firing and the zeroing of the firearm and to generate signals indicative thereof. For example, the app can be activated to, in real-time, detect, track, monitor and record one or more physical quantities related to, for example, the flight path of the projectile (e.g. bullet), projectile characteristics, user characteristics, firearm characteristics, the sighting device, and the target (before, during and after impact). Mobile device 18 may include a transceiver to receive and transmit data corresponding to the detected physical quantities.

In some embodiments, the Trajectory Data 42 is shown on display 34 of mobile device 18 in FIG. 8, wherein the app mobile device 18 is configured to detect the physical quantities of the projectile being shot from the firearm and impacting upon the target and to record the image of firing of the firearm so that the app automatically captures as a video the images of the shots fired to establish the shot group. Based on the formation of the shot group, in this embodiment, the app automatically calculates the Datum Point and Centroid Data 40, which can include the datum of the shot group, the centroid of the shot group, and the distance for adjustment of the sighting device to accurately fire the firearm.

In the example shown in FIG. 8, during the shooting process, the sensor dynamically measures, in real-time, one or more physical quantities of the ballistic data, like direction, angle, speed and velocity of the trajectory of the shot(s) fired, and converts the measurement data into a signal that can be measured electrically to calculate trajectory data. In various embodiments, the ballistic data can include, for example, distance, velocity, drag, shooting angle, sight height, bullet weight, bullet caliber, ballistic coefficient, sight height. In addition, environmental status, such as atmospheric (e.g., temperature, altitude, barometric pressure, humidity, speed of sound) and wind conditions (e.g., wind angle and wind speed), may be detect by the sensors and utilized to determine the trajectory data. In some embodiments, one or more of these measurements may be automatically calculated during the operation of the app as disclosed in the present teaching.

In lieu of or in addition to the automatic calculations, one or more of the parameters may be manually entered into mobile device 18 through user interface 36. For example, user 26 may be able to enter a ballistic type, bullet weight, bullet caliber, ballistic coefficient and other information. The information may be input in any number of ways, for example via a cab-mounted touch screen interface, via one or more buttons, via a keyboard, via speech recognition, via mobile device 18 (e.g., a smartphone or tablet) carried by the user 26, or in another manner known in the art. In some embodiments, user 26 may also be able to respond to inquiries received via mobile device 18, if desired. In addition to receiving manual input from user 26, mobile device 18 may also be capable of displaying information, for example instructions of sighting device adjustments (e.g., written instructions, audio instructions, and/or video instructions), trajectory data and recommendations, and, questions, etc.

To dynamically monitor, record, and analyze the parameters of the system and operation of the firearm zeroing process and trajectory data, the system, method and app can be configured, in various embodiments, to include sensors that detect and measure one or more of the following features:

Proximity sensors-sensors that can detect the presence of an object (i.e., the shots fired). Proximity sensors can include ultrasonic sensors, capacitive, photoelectric, inductive, or magnetic.

Motion detectors—sensors that are based on infrared light, ultrasound, or microwave/radar technology.

Image sensors—sensors that include digital cameras, camera modules and other imaging devices based on CCD or CMOS technology; Image sensors detect and convey the information that constitutes an image.

Resolution—sensors that can detect smallest changes in the position of the target.

Other types of sensors (e.g., IR sensors, RADAR sensors, LIDAR sensors, etc.) may also be utilized to determine characteristics of the firearm zeroing operation. Signals generated by the sensors may be communicated to a computing device and/or controller(s) and the appropriate controllers may use the signals to determine the conditions regarding the firearm zeroing operation. As described above, any one or more of the sensors may form an integral portion of mobile device 18 (e.g., the smartphone or tablet carried by the user) or a standalone component in wired or wireless communication with the computing device, and/or controllers, and/or mobile device 18, as desired.

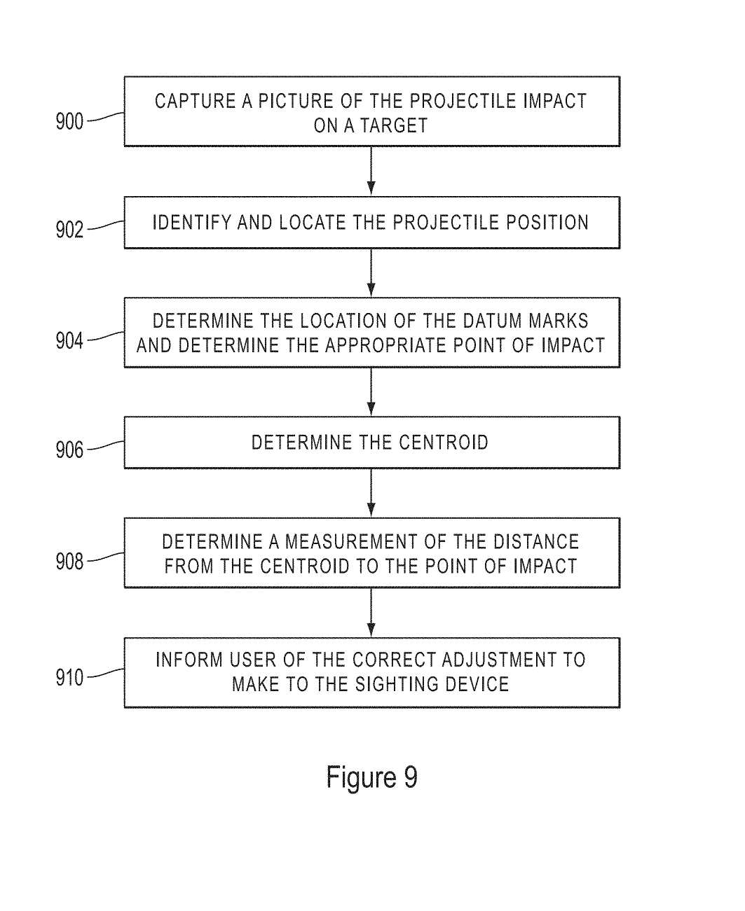

A flow chart of illustrative steps involved in zeroing a firearm using the firearm zeroing app disclosed in the present teaching is shown in FIG. 9.

In step 900, after several shots are fired on a target, a picture of one or more projectiles (e.g. bullet impact holes) on the target is captured using a camera.

In step 902, the app identifies and then locates the bullet impact holes.

In step 904, the app locates the datum marks of the bullet impact holes on the target and determine the appropriate point of impact for the rifle configuration.

In step 906, the app determines the centroid of the bullet impact holes.

In step 908, the app measures the distance from the centroid to the appropriate point of impact.

In step 910, the app informs the user of the correct adjustment to make on the user's sight.

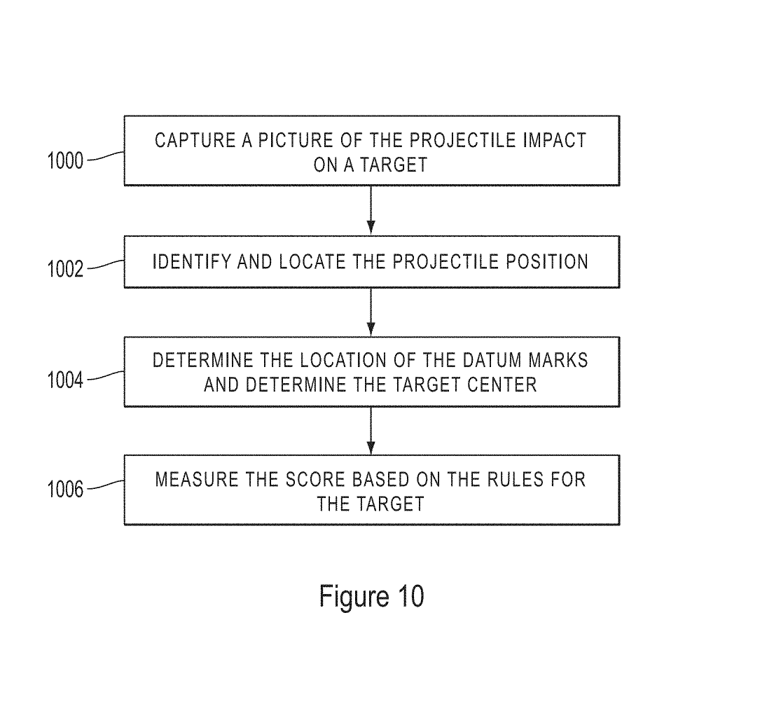

A flow chart of illustrative steps involved in scoring a training target using the firearm zeroing app disclosed in the present teaching is shown in FIG. 10.

In step 1000, after several shots are fired on a target, a picture of the bullet impact holes on the target is captured using a camera.

In step 1002, the app identifies and then locates the bullet impact holes.

In step 1004, the app locates the datum marks of the bullet impact holes on the target and determines the target center of the bullet impact holes.

In step 1006, the app measures the user's score based on the rules for the target.

It will be apparent to those skilled in the art that various modifications and variations can be made to the system and method of the present disclosure without departing from the scope its teachings.

Other embodiments of the disclosure will be apparent to those skilled in the art from consideration of the specification and practice of the teachings disclosed herein. It is intended that the specification and examples be considered as exemplary only.

What is claimed is:

1. A system for providing a firearm zeroing app, comprising:
an imaging analysis system for imaging an image of a plurality of projectiles impacted upon a target and configured to generate a first signal indicative of the image of the plurality of projectiles impacted upon the target;
a mobile device having a sensor internal to the mobile device, wherein the sensor is configured to generate a second signal associated with firearm zeroing analysis performed by the mobile device on the image of the plurality of projectiles impacted upon the target;
a controller in communication with the imaging analysis system, the mobile device, and the sensor, the controller being configured to:
analyze image data of the image of the plurality of projectiles impacted upon the target;
identify and locate one or more positions of the plurality of projectiles impacted upon the target;
determine datum marks based on the one or more positions of the plurality of projectiles upon the target;
determine a centroid based on the datum marks; and
determine a measurement of distance from the centroid to a point of impact on the target.

2. The system of claim 1, wherein the imaging analysis system comprises a camera for capturing the image of the plurality of projectiles impacted upon the target.

3. The system of claim 1, the target comprises:
a first surface and a second surface bearing multiple pieces of film attached to a single device;
each film having a first film surface and a second film surface; and
the first film surface of each film having a different optical property, enabling calibration of a variety weapon sighting technologies, including a night vision sight, a thermal imaging sight, and an aiming laser sight, using the single device

4. The system of claim 3, the target comprises:
a first surface and a second surface bearing multiple pieces of film attached to a single device;
each film having a first film surface and a second film surface; and
the first film surface of each film having a different optical property, enabling calibration of a variety weapon sighting technologies, including a night vision sight, a thermal imaging sight, and an aiming laser sight, using the single device.

5. The system of claim 3, wherein at least one of the pieces of film comprises a near infrared retro-reflective film for use with the night vision sight to identify a point of aim.

6. The system of claim 3, wherein at least one of the pieces of film comprises a near infrared retro-reflective film for use with the aiming laser sight to position an aiming laser.

7. The system of claim 3, wherein at least one of the pieces of film comprises a white light retro-reflective film for use with a visible aiming laser sight to position an aiming laser.

8. The system of claim 3, wherein at least one of the pieces of film comprises a thermal reflecting film for use with the thermal weapon sights to identify a point of aim.

9. The system of claim 3, wherein at least one of the pieces of film comprises a photo-luminescent film for use with the night vision sight to identify a point of aim without a use of an infrared illumination.

10. The system of claim 4, wherein at least one of the pieces of film detectable with the thermal weapon sight has a triangular cross-section defining an angle with respect to the first surface of the laminar target.

11. The system of claim 10, wherein the angle with respect to the first surface of the laminar target is within a range of approximately 5 degrees to 30 degrees.

12. The system of claim 3, wherein the multiple pieces of film comprise a laminar member.

13. The system of claim 10, wherein some of the multiple pieces of film comprises a laminar member and at least one of the multiple pieces of film comprises a non-laminar member.

14. The system of claim 10, wherein the non-laminar member comprises multiple member structure including a thermally reflective film, a folded laminar member, and a space filling member.

15. The system of claim 14, wherein the thermally reflective film is permanently adhered to the folded laminar member to form a hinge and the space filling member is configured to maintain the angle of the folded laminar member.

16. A system for providing a firearm zeroing app, comprising:
a tracking system for detecting and monitoring one or more physical quantities of a projectile propelled to impact upon a target;
an imaging analysis system for imaging an image of a plurality of projectiles impacted upon a target and configured to generate a first signal indicative of the image of the plurality of projectiles impacted upon the target;
a mobile device having a sensor internal to the mobile device, wherein the sensor is configured to generate a second signal associated with firearm zeroing analysis performed by the mobile device on the image of the plurality of projectiles impacted upon the target;
a controller in communication with the imaging analysis system, the mobile device, and the sensor, the controller being configured to:
record a video image of the one or more physical quantities of the projectile being propelled from the weapon to define a shot group;
analyze image data of the image of the plurality of projectiles impacted upon the target;
identify and locate one or more positions of the plurality of projectiles impacted upon the target;
determine datum marks based on the one or more positions of the plurality of projectiles upon the target;
determine a centroid based on the datum marks; and
determine a measurement of distance from the centroid to a point of impact on the target.

17. The system of claim 16, wherein the imaging analysis system comprises a camera for capturing the image of the plurality of projectiles impacted upon the target.

18. A method for providing a firearm zeroing app, comprising:
imaging an image of a plurality of projectiles propelled to impact upon a target;
analyzing image data of the image of the plurality of projectiles impacted upon the target;
identifying and locating one or more positions of the plurality of projectiles impacted upon the target;
determining datum marks based on the one or more positions of the plurality of projectiles upon the target;
determining a centroid based on the datum marks; and
determining a measurement of distance from the centroid to a point of impact on the target.

19. The method of claim 18, wherein the step imaging the image further comprises utilizing a camera to capture the image of the plurality of projectiles impacted upon the target.

20. The method of claim 18, further comprising propelling the plurality of projectiles from a firearm having a sighting mechanism mounted therein.
